(19) United States
(12) Patent Application Publication
(10) Pub. No.: US 2006/0232220 A1
(43) Pub. Date: Oct. 19, 2006

(54) Low frequency electronic ballast for gas discharge lamps

(75) Inventor: Janos Melis, Miami, FL (US)

Correspondence Address: Janos Melis, 3918 SW 61st Ave, Miami, FL, 33155, US

(73) Assignee: Ballastronic, Inc.

(21) Appl. No.: 11/105,155

(22) Filed: Apr. 13, 2005

(51) Int. Cl. H05B 37/02

(52) U.S. Cl. 315/209 R

(57) ABSTRACT

An electronic ballast for high intensity gas discharge lamps where the wave form of the lamp current is square wave providing acoustic resonance and flickering free operation. The circuit, having high efficiency, operates in a wide temperature range providing ideal ballast curve and reliable ignition for the lamps. Furthermore, significant energy saving can be achieved by its externally controlled built in dimming capability.

### CROSS-REFERENCE TO RELATED APPLICATION

Not Applicable

### BACKGROUND OF THE INVENTION

The present invention relates to a low frequency power converter and specifically to low frequency electronic ballasts for gas discharge devices. More specifically, the present invention relates to a low frequency square wave electronic ballast for high intensity discharge (HID) lamps. The prior art is replete with many known circuits providing electronic ballast for gas discharge lamps. For instance, high efficient electronic ballast which can be used with HPS (HID) lamps are discussed in U.S. Pat. No. 5,313,143 entitled “Master-slave half-bridge DC-to-AC switchmode power converter”, and U.S. Pat. No. 6,329,761 entitled “Frequency controlled half-bridge inverter for variable loads”, from the same inventor of the present invention. Furthermore, a low frequency square wave electronic ballast, especially for metal halide (MH) lamps are discussed in U.S. Pat. No. 5,428,268, entitled “Low frequency square wave electronic ballast for gas discharge devices”, also from the same inventor of the present invention. The present invention has several basic differences if compared to the previously mentioned low frequency square wave ballast.

Introduction of a new solution for zero current sensing (which is an important functional part for both the input and current source units), a simple temperature compensated nonlinear function generator, the implementation logic supplies for the floating switches of the low frequency full-bridge inverter are among the main improvements and a more effective ignition solution. Further low frequency electronic ballast are discussed in U. S. Pat. No. 5,710,488 entitled “Low-frequency high-efficacy electronic ballast”, from Nilssen, U.S. Pat. No. 4,614,898 entitled “electronic ballast with low frequency AC to AC converter” from Itani et al, 1986, U.S. Pat. No. 6,166,495 entitled “square wave ballast for mercury free arc lamp”, from Newell et al, and U.S. Pat. No. 5,235,255 entitled “Switching circuit for operating a discharge lamp with constant power” from Blom. Still further advantages of the present invention comparing to mentioned patent applications will become apparent from a consideration of the ensuing description and drawings.

An important application for high frequency switchmode power converters is supplying power to gas discharge devices, especially high intensity discharge (HID) lamps. Therefore, the efficiency of the conventional core&coil ballast can be significantly improved and the weight decreased. In the case of high frequency powering of gas discharge lamps, the high frequency ballast and the gas discharge lamp have a higher level of interaction than that which exists between a conventional low frequency ballast and gas discharge lamp. High frequency ballasts, where the frequency of lamp current higher than 4 kHz, may suffer from acoustic resonance which can cause various problems such as instability, high output fluctuation, or, in the worst case, cracked arc tubes. Therefore, an optimum solution to this problem is the use of a high frequency DC-to-DC switch-mode converter as a controlled current source connected to a low frequency DC-to-AC square wave inverter supplying the gas discharge lamp. Due to its lessened weight, higher efficiency and the nonexistence of flickering and acoustic resonances, this novel high frequency ballast providing low frequency square wave current for the HID lamps, has significant advantages when compared with either the conventional low frequency ballasts and the usual high frequency electronic ballast. Additionally, a new, high sophisticated electronic ballast generation can be introduced to provide several special features, such as, for example, automatic or controlled dimming providing significant energy saving in a wide temperature range.

### BRIEF SUMMARY OF THE INVENTION

It is an object of the present invention to provide an acoustic resonance and flickering free, high efficient low frequency square wave electronic ballast for high intensity gas discharge lamps operating in wide temperature range providing extended operational life time and energy saving.

A second object of the present invention to provide a dimmable electronic ballast for high intensity gas discharge lamps providing further energy saving.

A further object of the present invention to provide a high power factor input unit implementing a DC power supply for electronic ballast, wherein no electrolytic capacitors are used;

Another object of the present invention to provide a DC current source, wherein the output power can be externally controlled in a given range implementing dimming, wherein no electrolytic capacitors are used;

Further object of the present invention to provide a floating logic control circuit controlling a high frequency buck converter as a DC current source;

Another object of the present invention to provide a highly efficient square wave full-bridge inverter operating in a very wide frequency range including DC operation, wherein no electrolytic capacitors are used;

Further object of the present invention to provide a logic control circuit controlling a square wave full-bridge inverter implementing transition between the high (or zero) and the low frequency operations;

Another object of the present invention to provide a high frequency, high voltage ignition solution for reliable ignition of HID lamps.

Further object of the present invention to provide ideal ballast curve for HID lamps, wherein the lamp power is independent from the line voltage fluctuation and the lamp voltage increasing during the lamp life time;

These and other objects, features and advantages of the present invention will be more readily apparent from the following detailed description, wherein reference is made to the drawings.

### BRIEF DESCRIPTION OF THE DRAWINGS

In the drawings, closely related figures have the same numbers but different alphabetic suffixes.

FIG. 1A illustrates the block diagram of preferred electronic ballast for gas discharge lamps;

FIG. 1B shows the output voltage wave form of the Input Unit and the rectified input voltage

FIG. 1C illustrates the output voltage and current of the Current Source. It also shows the minimum level of its input voltage.

FIG. 1D shows the square wave lamp voltage and lamp current.

FIG. 1E illustrates the diagram of lamp current vs. lamp voltage and the preferred ballast curve FIG. 2A shows the circuit diagram of the Input Unit and its Control Unit. It also shows the Interface Unit and the Logic Supply.

FIG. 2B illustrates the current wave form of the main switch TI and its control signal.

FIG. 2C shows the current and voltage wave forms of rectifier D2 shown in FIG. 2A.

FIG. 2D shows the detailed circuit diagram of the Interface Unit, providing external dimming and ON/OFF control.

FIG. 2E illustrates the detailed circuit diagram of the Control Unit of the preferred Input Unit.

FIG. 3A illustrates the circuit diagram of the DC Current Source;

FIG. 3B shows the detailed circuit diagram of the Control Unit of the preferred DC Current Source shown in FIG. 3A;

FIG. 3C shows the basic wave forms of the preferred DC Current Source and its Control Unit.

FIG. 4A shows the circuit diagram of a Square Wave Inverter designated as the Output Unit in FIG. 1A and its Control Unit.

FIG. 4B shows the detailed circuit diagram of the Timer/Comparator subunit of the preferred Control Unit of the Square Wave Inverter;

FIG. 4C shows the detailed circuit diagram of the Logic Driver/Oscillator subunit of the preferred Control Unit of the Square Wave Inverter;

FIG. 4D shows the basic wave forms of the Current Limiter subunit of the preferred Control Unit of the Square Wave Inverter;

FIG. 4E shows the detailed circuit diagram of the Current Limiter subunit of the preferred Control Unit of the Square Wave Inverter;

FIG. 4F illustrates the HF to LF transition from circuit topological view.

FIG. 4G shows the basic current and voltage wave forms with respect to the high frequency (HF) to low frequency (LF) transition.

### DETAILED DESCRIPTION OF THE INVENTION

Generally, the high frequency electronic ballasts have shown limitation factors which severely restrict the availability of commercial applications for the HID lighting industry. Due to the fact that acoustic resonance is produced in a variety of different frequency ranges, which ranges are themselves dependent upon the lamp characteristics. In other words, a high frequency electronic ballast will cause acoustic resonance in some HID lamps, but not in others. Naturally, this draw-back makes it impossible to market a universally acceptable electronic HID ballast which may be used with any lamp other than a lamp with which the ballast has been specifically tested, in order to ensure that their is no acoustic resonance.

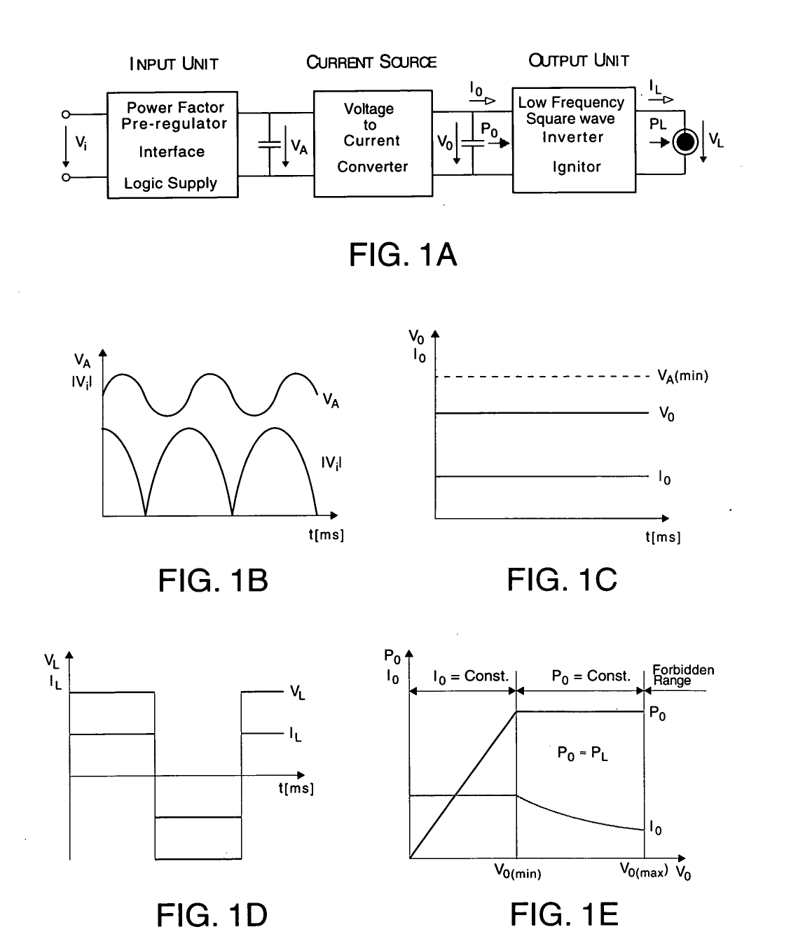

For overcoming the disadvantages of the high frequency electronic ballasts, an electronic ballast having high efficiency (≈95%) and low frequency square wave output current is suggested as illustrated in FIG. 1A including the main three units of the preferred low frequency square wave electronic ballast, namely:

an Input Unit, including a power factor preregulator, an interface circuit for external control, and logic supply providing stabilized 12V for the all control units of the ballast. The output voltage of the Input Unit (V1) and the rectified input voltage (Vi) are shown in FIG. 1B where the power factor Preregulator is based on a boost converter configuration;

a Current Source, which can be considered as a voltage to current converter implementing the ideal ballast curve shown in FIG. 1E. In this case, the current in low output voltage (0<20V) can be lowered, but it should be sufficiently high, forcing the transition from glow discharge to arc discharge at a certain glow discharge voltage determined by the lamp. FIG. 1C shows the output voltage and current levels determined by the lamp, if the current source is based on a buck converter configuration (V₁>V₀);

an Output Unit (full-bridge inverter), as a solution to the acoustic resonance problem caused by high frequency lamp current, low frequency (50 Hz-500 Hz) square wave lamp current is implemented as it is shown in FIG. 1D. In the case of a low frequency square wave lamp current, the temperature modulation of the central discharge channel is almost zero. However, since the polarity change of the lamp current is not instantaneous, especially if a low inductance ignitor transformer is connected in series with the lamp, the lamp power fluctuates twice of the current frequency. Since the transition is very fast (<10 μs) with respect to a half-period (5-10 ms), the flickering is negligible. Also, for the same reason, the high frequency harmonics of the lamp current are significantly smaller than in the high frequency case.

From electronic circuit viewpoint a square wave ballast is more complex than a simple high frequency inverter. It should contain at least two power unit, namely a power controlled current source and a low frequency full-bridge inverter. Furthermore, if high power factor is required, it should be also included a high power factor pre-regulator. Therefore, the increased complexity and higher cost of a low frequency square wave electronic ballast may restrict its industrial application to areas where special requirements are demanded, namely extremely wide temperature range and flickering free operation. Special circuit solutions for overcoming the technical barriers from ballast and electronic circuit viewpoints will be presented in the following detailed descriptions.

Input Unit

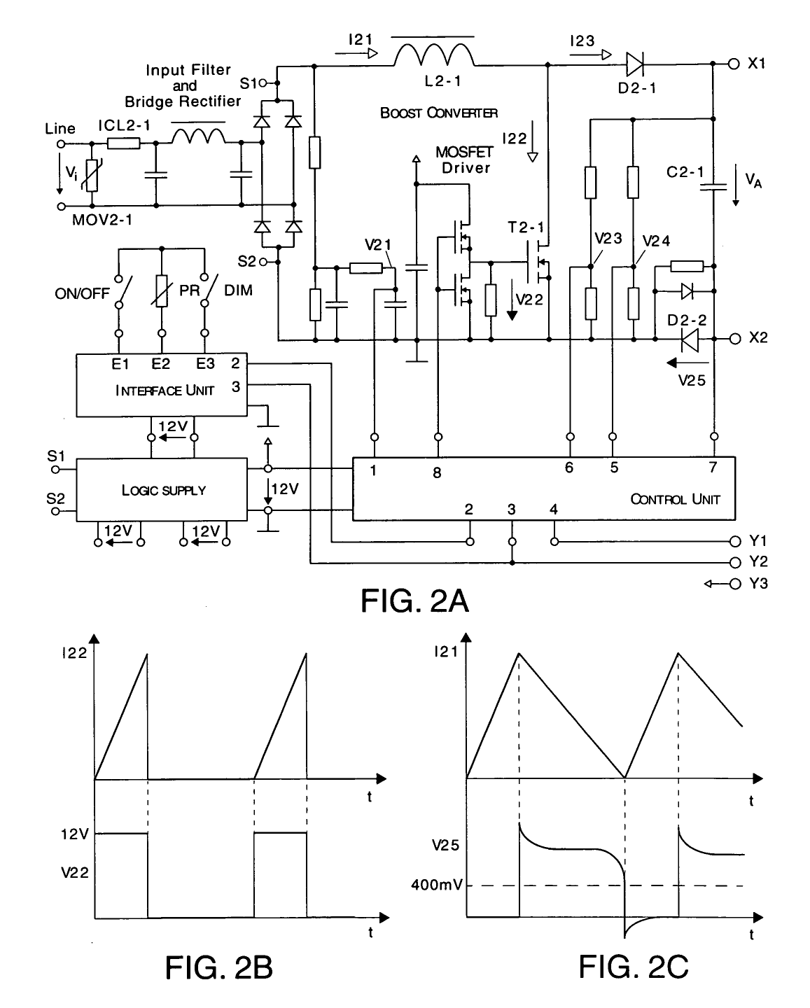

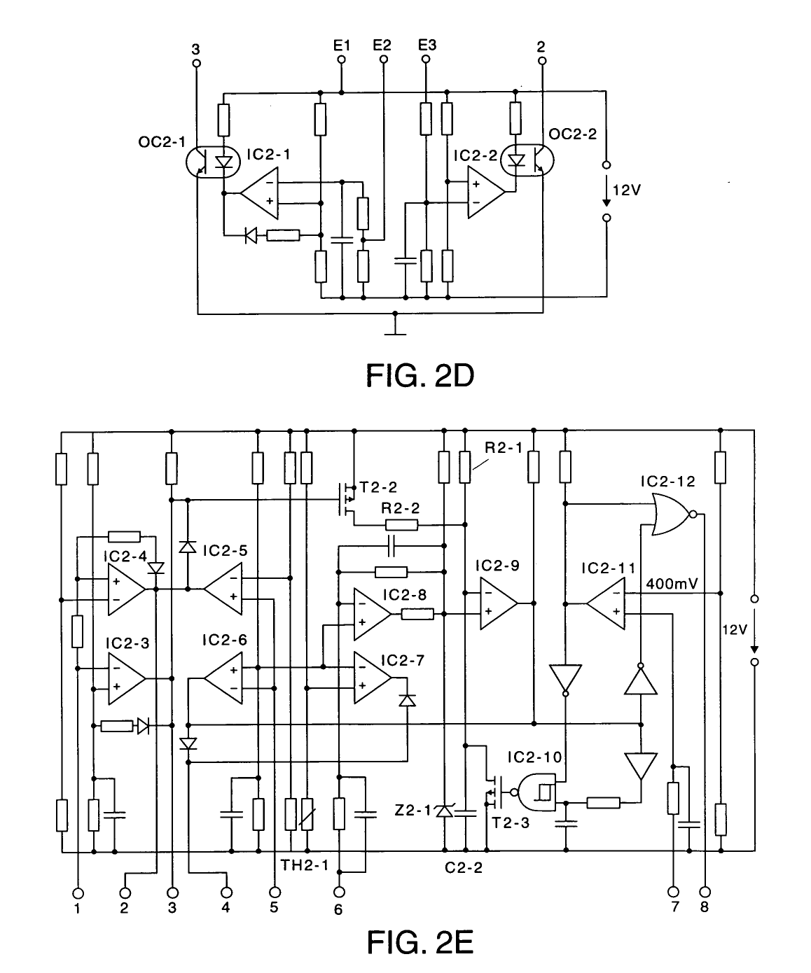

The overall efficiency and the cost of an electronic ballast device is crucial. Therefore, only a simple but very highly efficient (>97%) circuit solutions can be considered still providing high power factor and low total harmonic distortion. Since a simple rectifier and filter can produce large third harmonic distortion and the power factor is extremely low (<50%), application of a high power factor input unit (pre-regulator) is required. In this case the relative simplicity and very high efficiency can be considered as the main design goals. From industrial application viewpoint the very low THD (<3%) and the ideal power factor(l00%) are not required. An acceptable compromise is: THD<10% and PF>97%. According to these requirement, as it is shown in FIG. 2A, a boost converter configuration in discontinuous border mode can be considered as the optimum solution even if the amplitude of the inductor current is higher then in continuous mode. In this case, the zero current switching, especially at higher voltages (200V -400V) dramatically decreases the stress of the switches, therefore increasing the reliability and efficiency of the overall circuit. In FIG. 2A the main components of boost converter—connected to the Input Filter—are the Inductor L2-1, MOSFET T2-1FIG, Rectifier D2-1, and Capacitor V_{A}. The DC voltage V21 is proportional to the average value of input voltage. Rectifier D2-2 provides zero current sensing when T2-1 is OFF. FIG. 2A also shows the Interface Unit providing isolated dimming and ON/OFF external control. Furthermore, a Logic Supply Unit providing stabilized 12V for the control units of the ballast is also illustrated in FIG. 2A.

FIG. 2B illustrates the current wave form of the main switch implemented by power MOSFET T2-1 and its gate control signal V22. FIG. 2C shows the inductor current I21 in the discontinuous border mode, and the voltage signal V25 on rectifier D2-2 providing a simple and effective (low power loss) solution for the zero current sensing of the inductor L, where no shunt resistor is applied. Therefore, using a simple comparator (see IC2-11 in FIG. 2E), the zero/nonzero values of the inductor current can be easily converted to digital signal. Controlled On-time and zero current switching on techniques are applied. Therefore, the peak and average inductor current is sinusoidal as is the input voltage. Furthermore the control of the circuit in discontinuous mode, based on the constant On Time method, can be easily implemented (no right plane zero) increasing the reliability and efficiency of the overall circuit.

FIG. 2D shows the circuit diagram of the Interface Unit based on comparators IC2-1 and IC2-2. The whole Interface Unit is isolated from the main part of the ballast (therefore, from the line) and the control connection is implemented by optoisolators OC2-1 and OC2-2. The dimming(E1-E3) can be externally controlled by a simple low power switch (DIM) as it is shown in FIG. 2A. The ON/OFF control(E1-E2) can be also realized by a low power switch, or if it is required, with a photoconductive cell (PR).

FIG. 2E shows the detailed circuit diagram of the preferred Control Unit of the Input Unit including:

(a) an error amplifier IC2-8 controlling the output voltage V_{A};

(b) a sawtooth generator implemented by a resistor R2-1 (R2-1×R2-2 in case of dimming controlled by low power MOSFET T2-2), a capacitor C2-2, a low power MOSFET T2-3 and a NAND Schmitt-trigger IC2-10;

(c) an ON-time controller implemented by comparator IC2-9, where the inputs are connected to the sawtooth generator and the error amplifier IC2-8 where the maximum on-time is limited by Zener diode Z2-1;

(d) a zero current sensing comparator IC2-11 connected to the rectifier D2-2 and an approximately 4000 mV voltage source;

(e) the voltage comparators IC2-3 and IC2-4 are controlled by voltage V21 which is proportional to the average value of the rectified input voltage Vᵢ, and voltage comparators IC2-5 and IC2-6 are controlled by the output voltage (V_{A}) of the boost converter;

(f) a temperature controller is implemented by voltage comparator IC2-7 controlled by thermistor TH2-1;

(g) a dual input NOR gate controlling the MOSFET Driver of T2-1 (FIG. 2A), where the inputs are connected to the zero current sensing comparator IC2-11 and the ON-time controller comparator IC2-9.

An essential difference between the preferred high power factor preregulator of the present invention and standard regulators, is the zero current sensing. In this case, the voltage drop on rectifier D2-2 is compared to the zero level of the control unit providing sensitivity and less loss. This solution is effective if the main switch (T2-1) is switched on at zero inductor current level as in the preferred embodiment. A further difference between the preferred high power factor preregulator and standard regulators, is the utilization in the present invention, of a relatively small value film capacitor (C2-1) instead of employing a large value electrolytic capacitor as the output capacitor. In the case, the fluctuation (120 Hz) of the output voltage V_{A} is large as it is illustrated in FIG. 2B.

Current Source

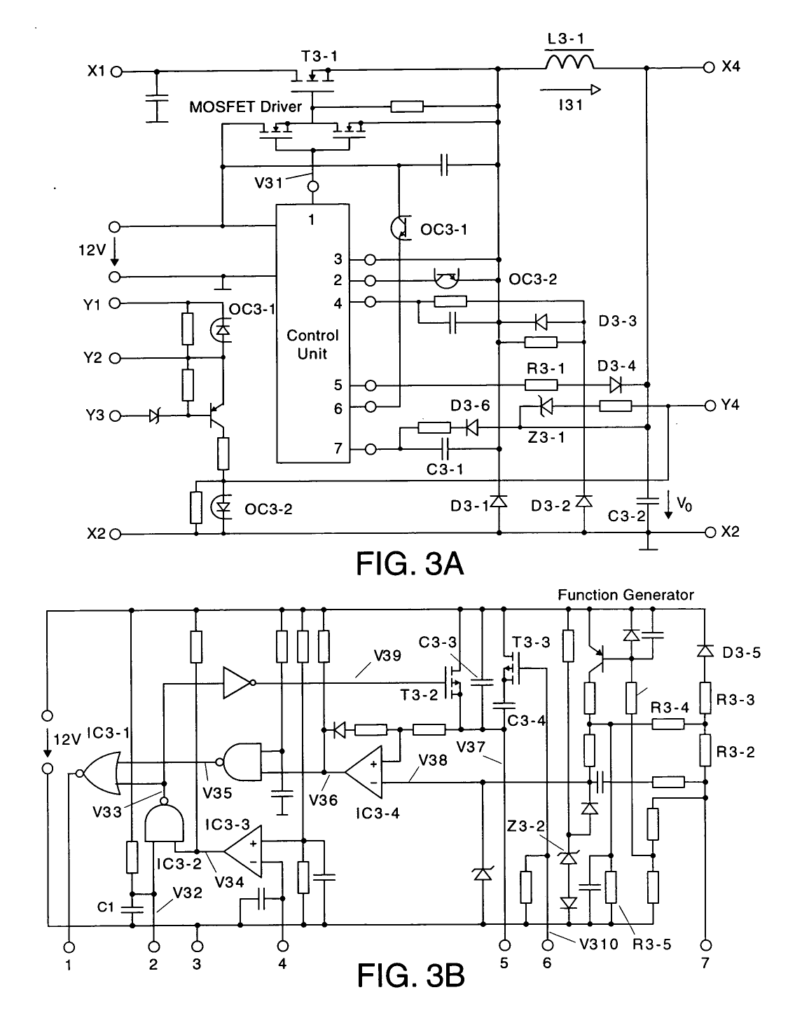

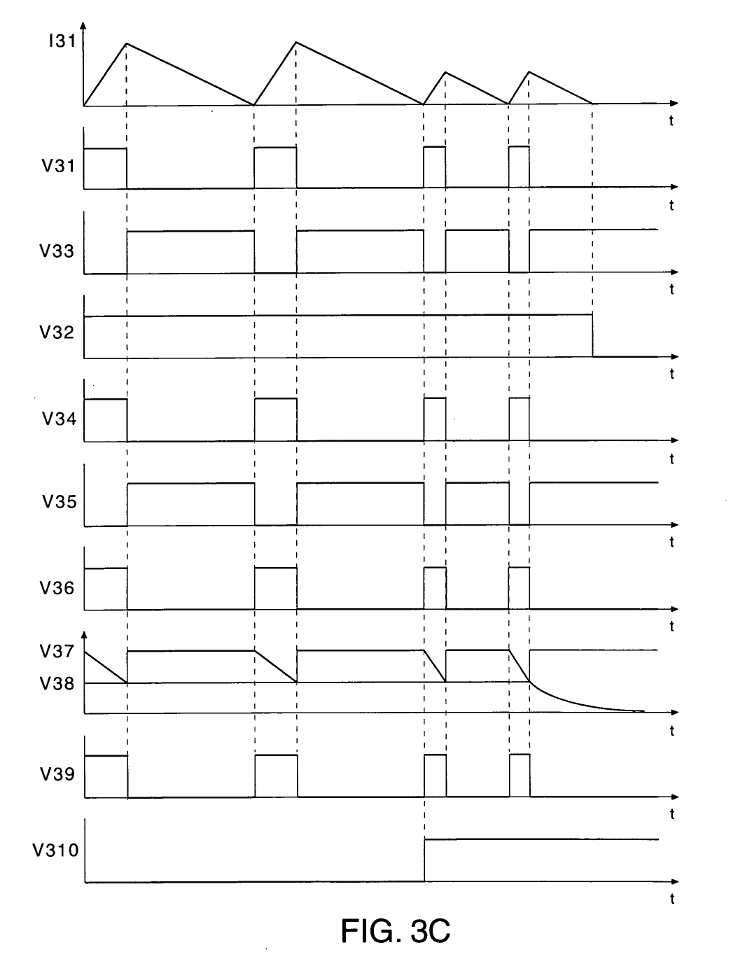

With the exception of boost derived converters, several converter configuration may applied as the current source. It can be seen that a basic buck converter as the current source of the low frequency square wave ballast may be an obvious choice, shown in FIG. 3A. Avoiding extra stress and loss in the switches (T3-1, D3-1), discontinuous border mode for the inductor current I31 is chosen as it is shown in FIG. 3C. In this case, the known stability problems of the continuous mode are avoided and a special control method can be applied as the preferred solution. FIG. 1E shows the required output power and current vs. output voltage characteristics as the ideal ballast curve for HPS (HID) lamps. The minimum and maximum output voltages are determined by the nominal lamp voltages (100V/55V for HPS, and 130V for MH lamps).

The applied control method is significantly different from the usual ones as it will demonstrated in the following part. The control unit, shown in FIG. 3A, is connected directly to the MOSFET—Driver and therefore to the main switch T3-1.

The zero current sensing of the inductor current I31 implemented by a fast rectifier D3-2 connected in series with a Schottky-rectifier D3-3 which rectifiers are connected in parallel with the main rectifier D3-1. If the main switch T3-1 is OFF, the main rectifier D3-1 is ON and an approximately 200 mV voltage drop occurs across the Schottky-rectifier D3-3. This voltage controls a voltage comparator IC 3-3 (FIG. 3B) connected to an input of NAND Schmitt-trigger IC3-2, which forces T3-1 OFF, and allowing the ON state of the main switch T3-1 at zero inductor current.

The mapping of inductor current 131 in the ON state of the main switch T3-1 is implemented by rectifier D3-4 connected in series with resistor R3-1 providing charge current for capacitor C3-3. Therefore, the voltage (12-V37) is proportional to the inductor current I31, since both the inductor current and the capacitor voltage V37 depend linearly on the same voltage: V_{A}-V₀. Therefore, the peak inductor current as well as the average inductor current can be directly controlled by a reference voltage V38 (FIG. 3B). The discharge of the capacitor C3-3 is achieved by a low power p channel MOSFET T3-2 controlled by the zero current sensing voltage comparator IC3-3 shown in FIG. 3B.

The control of output power can be achieved by implementing the proportionality of the reference voltage V38 to the inverse value of output voltage V₀. Therefore, the control of the constant output power can be solved in a certain range of output voltage. Generally, for HID lamps, this output voltage range is: 80V-160V. Continuous dimming of the output power (lamp power) can be achieved by a continuous decrease of the value of resistor R3-1. The output power can be changed in discrete steps by the values of capacitor C3-3. FIG. 3B shows a solution for this case, where a second capacitor C3-4 is connected parallel with C3-3 controlled by a low power MOSFET T3-3 via an optocoupler OC3-2 providing isolation. Actually, in this case, the full power is provided when MOSFET T3-3 is ON, and dimmed operation if MOSFET T3-3 is OFF. Dimming can be advantageous from an energy saving consideration if the decreased light level is acceptable in certain situations.

The electronic realization of the required inverse relationship is implemented by a nonlinear Function Generator shown in FIG. 3B, based on resistors R3-2, R3-3, R3-4, R3-5, and diode D3-4. The output voltage V₀ boosted to the floating control level by rectifier D3-6 and a smoothing capacitor C3-1 as it shown in FIG. 3A providing the appropriate voltage level for the function generator.

The voltage comparator IC3-4 controls the ON time of the main switch T3-1. The dual input NOR gate IC3-1 is controlled by the voltages V33 (V32 and V34) and V35 (V36), and its output is connected to the MOSFET Driver shown in FIG. 3A.

The output voltage V₀ is limited by applying a Zener diode Z3-1 connected in series with the optocoupler OC3-2 providing OFF-state for the main switch T3-1. The corresponding signal wave forms of the circuit diagrams of figures FIG. 3 A and FIG. 3 B are illustrated in FIG. 3C.

Output Unit

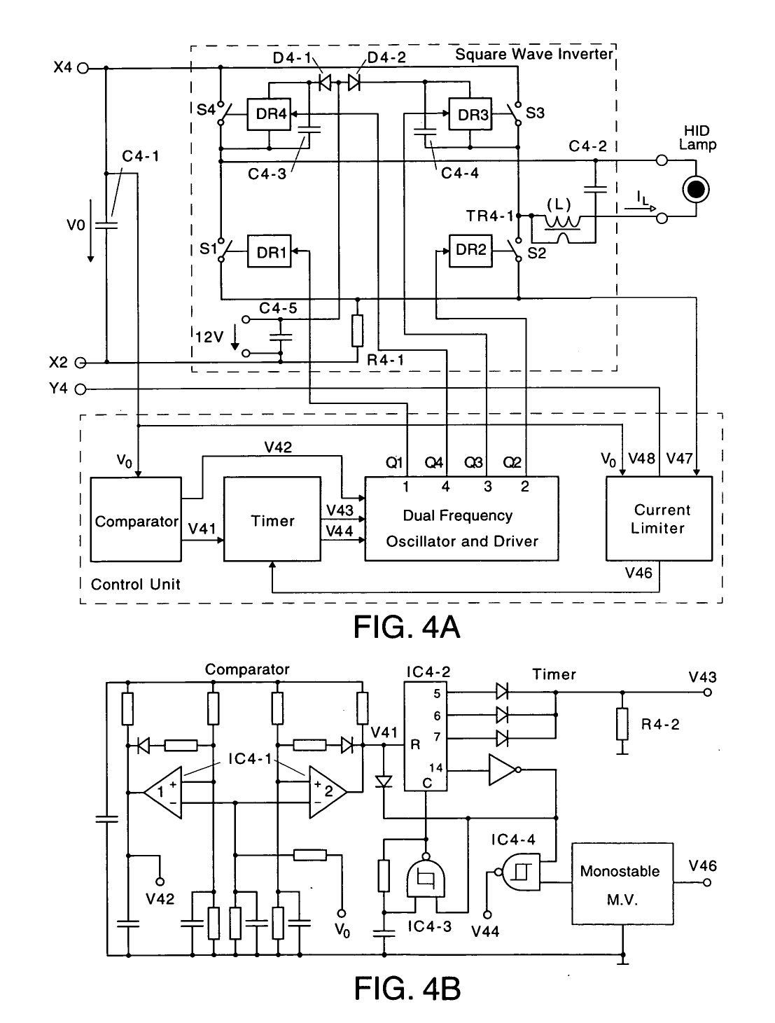

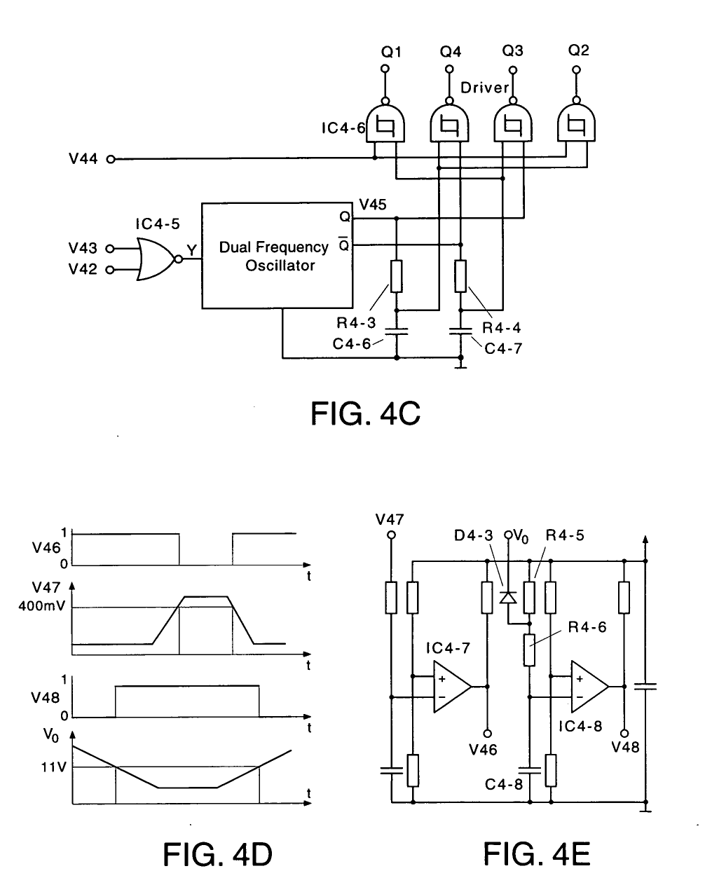

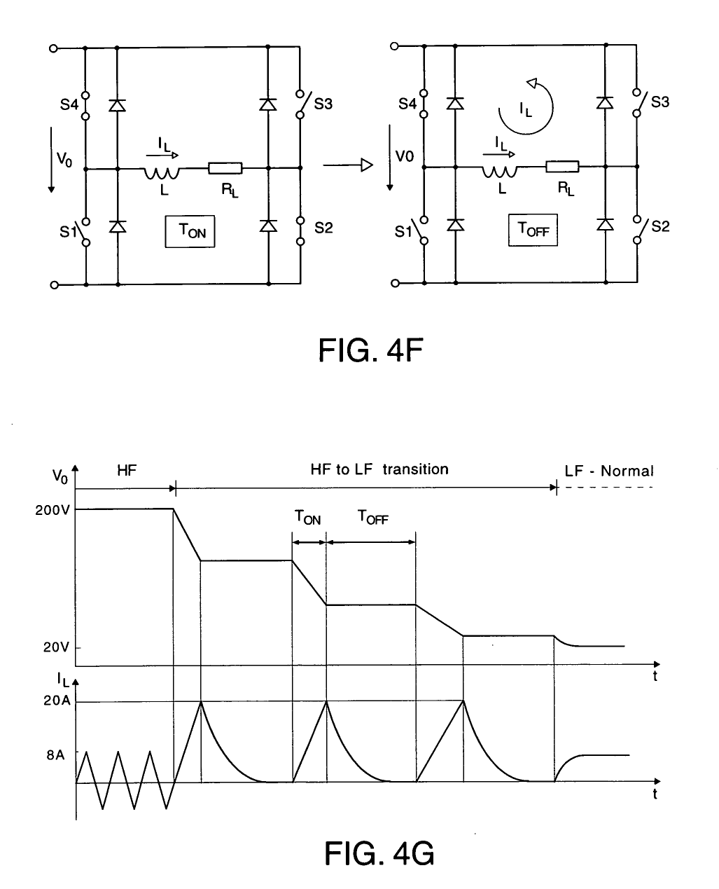

HID lamps are usually supplied (avoiding cataphoretic phenomenon) with symmetrical AC current. Therefore, a symmetrical (D=50%) square wave inverter should be connected to the DC current source including high voltage ignitor circuit. Since the nominal frequency of the inverter is low (50 Hz-500 Hz), only the full-bridge configuration can be considered as it is shown in FIG. 4A including a Square Wave Inverter and its Control Unit. The inverter should also operate at high frequency for limited time (≈4s) periodically when the lamp start-up requires increased voltage.

Therefore, the application of MOSFET's are recommended as the main switches (S1, S2, S3 and S4), requiring appropriate drivers (DR1, DR2, DR3 and DR4). The supply voltages are boosted by rectifiers D4-1 and D4-2 to capacitors C4-3 and C4-4 respectively, wherein their cathodes are connected to capacitor C4-5 charged by 12V Logic Supply. For instance, C4-3 is charged when S1 is switched on. For ignition purposes, a small pulse transformer TR4-1 is connected in series with lamp. At low frequency, the effect of the transformer can be neglected except for a short time at switching points. The high frequency harmonic components of the lamp current is much lower than at high frequency operation. It follows that the instantaneous power is constant, similarly to the DC operation, except at the switching points, where it goes to zero in a short time interval (≈15 μs). The inductance of the secondary side of the ignition transformer TR4-1 can be utilized for short circuit protection. In this case the peak current can be controlled by a simple circuit, as the current is converted to a proportional voltage signal by resistor Rs.

(A) TIMER AND COMPARATOR. The maximum output voltage range is determined by the current source(0<V₀<200V). Inside this range the load (lamp) determines the output voltage. When the voltage of an aging lamp achieves approximately 160V, the lamp should be switched off after a certain time delay (12 min.). Furthermore, there should be another (≈170V) voltage level, where the output unit start to operate at high frequency providing sufficiently high ignition voltage for the lamp. Sensing of these two voltage level and converting into digital signals, based on a dual comparator IC4-1 (controlled by V₀); is implemented by the Comparator unit shown in FIG. 4B. If V₀<160V, V41=V42=12V. When V₀>160V, the signal V41=0, and when V₀>170V, the signal V42=0. The Timer unit, controlled by signal V41, is also shown in FIG. 4B, including a ripple counter (IC4-2) connected to a simple oscillator based on the Schmitt-trigger IC4-3, a dual input AND-gate IC4-4, and a monostable multivibrator controlled by signal V46. The inverted output 14 of the ripple counter IC4-2 and the output of the monostable multivibrator are AND-gated resulting signal V44. After a predetermined time (approximately. 12 min.), the output signal V44 becomes zero, therefore the inverter will be stopped (see FIG. 4C). Selected outputs of the ripple counter (in our case 5, 6, and 7) are OR-gated to resistor R4-2 providing the output signal V43. As we shall see, the frequency (high or low) of the full-bridge inverter (therefore, the lamp current) is controlled by V43.

With respect to the output voltage V₀, the operation of the Output Unit can be summarized as follows:
V₀<160V→Low frequency operation; 1.
160V<V₀<170V→Low frequency operation, Timer starts; 2.
V₀>170V→High frequency operation. 3.
As we shall see later, when the output voltage decreases to a certain low value (<10V), indicating short circuit, within a short time the Output Unit and the Current Source will be switched off (see Current Limiter) implementing special short circuit protection for the ballast.

(B) DUAL FREQUENCY OSCILLATOR AND DRIVER. The Dual Frequency Oscillator, shown in FIG. 4C, provides symmetrical square wave voltage signal V45 (see output Q). The high frequency (HF) or low frequency (LF) operation of the Dual Frequency Oscillator is controlled by signal Y, where

$$Y = \overline{V 42 + V 43} = \{ \begin{matrix}1 \to HF operation \\ 0 \to LF operation\end{matrix}$$

In practice, the low frequency range can be 50 Hz-200 Hz. Lower then 50 Hz can cause flickering as the cataphoretic phenomenon starts to occur. The high frequency range can start at 20 KHz. Essentially higher frequency is not recommended because the increased switching losses. Since the inverter also operates at high frequency as the lamp needs increased voltage at start up, relatively powerful MOSFET drivers should be applied. The MOSFET derivers (DR1, DR2, DR3 and DR4) are controlled by driver signals Q1, Q2, Q3 and Q4, provided by the Driver subunit is also shown in FIG. 4C. The Driver includes a quad, dual input AND gate IC4-6. The upper MOSFET drivers DR3 and DR4 should include optoisolators having relatively long delay times (>1 μs). Therefore, avoiding the cross conductions of the main switches (S1-S4, S2-S3), the driver signals Q3 and Q4 should be delayed according to Q2 and Q1. The delay time (2 μs-5 μs) for the upper switch S3 (signal Q3) can be adjusted by R4-3 and C4-6 as it is shown in FIG. 4C. Similarly, the delay time (2 μs-5 μs)for upper switch S4 (signal Q4) can be adjusted by R4-4 and C4-7 as it is also shown in FIG. 4C

(C) CURRENT LITER. The Current Limiter unit, shown in FIG. 4E, includes the low voltage comparators IC4-12 and IC4-13, where the inverting input of IC4-12 is connected to the current sensing resistor Rs shown in FIG. 4A. The inverting input of comparator IC4-7 is connected to the output of the Current Source (V₀). The resistors R4-5, R4-6 and capacitor C4-8 are connected in series, where the common point of resistor R4-6 and capacitor C4-8 is connected to the inverting input of IC4-8. Because of rectifier D4-3 connected to the common point of resistor R4-5 and R4-6, the voltage on the inverting input is effected by the output voltage V₀ if it is lower then approximately 11V. The corresponding signal wave forms are shown in FIG. 4D. If the output current increases above a certain level, than V46=0, and the monostable circuit of Timer unit will be triggered implementing peak current limitation. When the output voltage V₀, depending on the load impedance, decreases bellow approximately 11V, the output V48 goes to 1 and Current Source switches off, implementing short circuit protection. The main advantage of this solution that the actual short circuit operation exists only for a short time and the ballast is switched off until the short circuit condition exists (nearly zero output impedance).

FIG. 4F and FIG. 4G show a detailed illustration of the transition process from high frequency to low frequency operation and the short circuit protection. As it was previously described the Current Limiter unit switches off both the lower switches of the inverter and the Current Source for a certain predetermined time if the current reaches a certain level, for instance 20A. This way the maximum peak current in the MOSFET's can be limited to a safe level, even at increased temperature.

Thus, while preferred embodiments of the present invention have been shown and described in detail, it is to be understood that such adaptations and modifications as occur to those skilled in the art may be employed without departing from the spirit and scope of the invention, as set forth in the claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A high efficient low frequency square wave electronic ballast for high intensity discharge lamps, comprising:
a high power factor preregulator providing approximately sinusoidal input current, therefore high power factor, and further providing a constant average DC voltage source; and further comprising,
a constant power DC current source implementing the ideal ballast curve for high intensity discharge lamps in their typical voltage range, especially for metal halide and high pressure sodium lamps; and still further comprising,
an output unit providing low frequency symmetrical square wave current avoiding cataphoretic phenomenon, and further providing an appropriate high frequency ignition voltage source for high intensity discharge lamps; wherein,
the input of high power factor preregulator is connected to a sinusoidal AC voltage source typically the line voltage, and the output of high power factor preregulator is connected to the input of constant power DC current source, and the output of constant power DC current source is connected to the input of output unit, and the output of output unit is connected to a high intensity discharge lamp.

13. A high power factor preregulator in accordance with claim 12, comprising:
a boost converter, having an inductor, a controlled electronic switch, an output capacitor, a first rectifier, a second rectifier, a low voltage comparator and a stabilized reference DC voltage source; wherein,
the anode of second rectifier is connected to the lower potential end of controlled electronic switch and the cathode of second rectifier is connected to the lower potential end of output capacitor; and further wherein,
the anode of second rectifier is connected to the noninverting input of low voltage comparator, and the inverting input of low voltage comparator is connected to the stabilized reference DC voltage source.

14. A constant power DC current source in accordance with claim 12, comprising:
a buck converter having an inductor, a controlled electronic switch, first capacitor as output capacitor, a second capacitor, a first rectifier, a second rectifier, a third rectifier, a fourth rectifier, a fifth rectifier, a Zener diode, a first resistor, a second resistor, an optocoupler, and a logic control unit; wherein,
the anode of second rectifier is connected to the anode of first rectifier, the cathode of second rectifier is connected to the anode of third rectifier and digital control unit, and the cathode of third rectifier is connected to the cathode of first rectifier; still further wherein,
the anode of fourth rectifier is connected to first capacitor as output capacitor, the cathode of fourth rectifier is connected to the first end of second capacitor and digital control unit, and the other end of second capacitor is connected to the common point of the controlled electronic switch, inductor and first rectifier; further wherein,
the cathode of Zener diode is connected to an end of second resistor, another end of second resistor is connected to the input of optocoupler, and the output of optocoupler is connected to digital control unit; still further wherein,
the cathode of fifth rectifier is connected to first capacitor as output capacitor, the anode of fifth rectifier is connected to an end of first resistor, and the other end of first resistor is connected to digital control unit.

15. A logic control unit in accordance with claim 14, comprising:
a nonlinear function generator, a first and a second comparators, a third capacitor connected parallel with a transistor, a stabilized DC voltage source; wherein,
the said first resistor is connected to an end of third capacitor, the other end of third capacitor is connected to the stabilized DC voltage source, the anode of said third rectifier is connected to the inverting input of second comparator, the noninverting input of second comparator is connected to a reference DC voltage source, the output of second comparator is connected to transistor, the inverting input of first comparator is connected to nonlinear function generator, and the noninverting input of first comparator is connected to the common point of said first resistor and third capacitor.

16. A nonlinear function generator in accordance with claim 15, comprising:
a second resistor, a third resistor, fourth resistor, fifth resistor, sixth resistor, a sixth rectifier, a seventh rectifier, and a Zener diode; wherein,
the first end of second resistor is connected to first end of said second capacitor, the second end of second resistor is connected to the first end of third resistor, the second end of third resistor is connected to the anode of sixth rectifier, the cathode of sixth rectifier is connected to a constant voltage source, the common point of second and third resistor is connected to the first end of the fourth resistor, the second end of fourth resistor is connected to the first end of the fifth resistor, the second end of fifth resistor is connected to the zero level of the constant voltage source, the first and of the seventh resistor is connected to the constant voltage source, the second end of the seventh resistor is connected to the cathode of the Zener diode, the anode of Zener diode is connected to the zero level of said DC voltage source, the common point of seventh resistor and Zener diode is connected to the anode of seventh rectifier, the cathode of seventh rectifier is connected to the common point of fourth and fifth resistors, and the common point of fourth and fifth resistors is connected to the noninverting input of said first comparator.

17. An output unit in accordance with claim 12, comprising:
a full-bridge inverter having, a first, second, third and a fourth electronically controlled switches, an ignition transformer having a first and a second winding, a first and a second rectifier, a first, a second capacitor, a shunt resistor, a control unit, a logic supply, and a high intensity discharge lamp as load; wherein,
the first winding of ignition transformer is connected to an end of high intensity discharge lamp and the first output connecting point of fall-bridge inverter, the second winding of ignition transformer is connected to the an end second capacitor and the first output connecting point of fill-bridge inverter, the other end of second capacitor is connected to second output connecting point of full-bridge inverter, the other end of high intensity discharge lamp is connected to the second output connecting point of full-bridge inverter, the common point of the third and fourth electronically controlled switches is connected to an end of first capacitor, the common point of first and second electronically controlled switches is connected to an and of shunt resistor, and the another end of shunt resistor is connected to another end of first capacitor, the control inputs of first, second, third and fourth electronically controlled switches are connected to control unit, and the cathode of first and second rectifier is connected to the fourth and third electronically controlled switches respectively, and the common anode of first and second rectifiers are connected to the logic supply.

18. A control unit in accordance with claim 17, comprising:
a comparator unit, having an input, a first and a second output; a timer unit, having a first and a second input, a first and a second output, a dual frequency oscillator and driver unit, having a first, a second, and a third input, further having a first, a second, a third, and a fourth output, a current limiter unit, having, a first and a second input, a first and a second output; wherein,
the first input of comparator unit is connected to the input of said full-bridge inverter, the first output of comparator unit is connected to the first input of timer unit, the second output of comparator unit is connected to the second input of dual frequency oscillator unit; further wherein,
the second input of timer unit is connected to the second output of current limiter unit, the firs%t output of timer unit is connected to the first input of dual frequency oscillator unit, the second output of timer unit is connected to the second input of logic driver unit; still further wherein,
the output of dual frequency oscillator unit is connected to the first input of logic driver, the first output of the logic driver is connected to said first electronically controlled switch, the second output of the logic driver is connected to said second electronically controlled switch, the third output of the logic driver is connected to said third electronically controlled switch, the fourth output of the logic driver is connected to said fourth electronically controlled switch; still further wherein,
the first input of current limiter unit is connected to said shunt resistor, the second input of current limiter unit is connected to the input of the said full-bridge inverter, the first output of current limiter is connected to the second input of timer unit, and the second output of current limiter is connected to the input of said optocoupler of claim 14.

19. A comparator unit in accordance with claim 18, comprising:
a first and a second voltage comparator, a first and a second DC voltage source; wherein,
the common point of the inverting inputs of the first and the second voltage comparators act as the input of the said comparator unit, the output of the first voltage comparator acts as the first input of said comparator unit, and the output of the second voltage comparator acts as the second output of said comparator unit; further wherein,
the noninverting input of first voltage comparator is connected to the first DC voltage source, the noninverting input of second voltage comparator is connected to second DC voltage source.

20. A timer unit in accordance with claim 18, comprising:
a digital ripple counter having a first, a second, a third and a fourth output, a digital oscillator, a dual input NAND-gate, a monostable multivibrator, and a resistor, wherein,
the reset input of the digital ripple counter acts as the first input of the said timer unit, the input of the monostable multivibrator act as the second input of said timer unit, the output of the dual input NAND-gate act as the first output of said timer unit, and the signal of on the resistor act as the second output of said timer unit; further wherein,
the digital oscillator is connected to the digital ripple counter providing clock signal, the first, second and third outputs of digital ripple counter are OR-gated to the resistor, the inverted fourth output of digital ripple counter is connected to an input of dual input NAND-gate, and the output of monostable multivibrator is connected to another input of dual input NAND-gate.

21. A dual frequency oscillator and driver unit in accordance with claim 18, comprising:
a dual frequency digital oscillator having a control input, a noninverting and an inverted output, a dual input NOR-gate, a first, a second, a third and a fourth dual input NAND-gate, a first and a second capacitor, a first and a second resistor; wherein,
the inputs of dual input NOR-gate act as the first and the second inputs of said dual frequency digital oscillator and driver unit, the third input of said dual frequency digital oscillator and driver unit is connected to an input of first and the fourth dual input NOR-gate, the output of dual input NOR-gate is connected to the control input of the dual frequency digital oscillator, the noninverting output of the dual frequency digital oscillator is connected to an input of third the dual input NAND-gate, the inverted output of the dual frequency digital oscillator is connected to an input of second dual input NAND-gate; further wherein,
the noninverting output of dual frequency digital oscillator is connected to an end of the first resistor, another end of the first resistor is connected to the first capacitor, the common point of first resistor and first capacitor is connected to an input of second dual input NAND-gate, the inverted output of dual frequency digital oscillator is connected to an end of the second resistor, another end of the second resistor is connected to the second capacitor, the common point of second resistor and second capacitor is connected to an input of third dual input NAND-gate, the outputs of the first, second, third and the fourth dual input NAND-gates act as the first, second, third and the fourth outputs of dual frequency oscillator and driver unit.

22. A current limiter unit in accordance with claim 18, comprising:
a first and a second voltage comparator, a first and a second reference voltage source, a first, a second, and a third resistor, a rectifier, and a capacitor; wherein,
an end of the first resistor act as the first input of said current limiter unit, another end of the first resistor is connected to the inverting input of first voltage comparator, the noninverting input of first voltage comparator is connected to the first reference voltage source, the output of first comparator act as the first output of said current limiter unit; further wherein,
an end of the second resistor is connected to an end of third resistor and to the anode of rectifier, the cathode of rectifier acts as the second input of said current limiter unit, an another end of third resistor is connected to the capacitor, the common point of third resistor and the capacitor is connected to the inverting input of the second voltage comparator, the noninverting input of second voltage comparator is connected to the second reference voltage source, the output of the second voltage comparator acts as the second output of current limiter unit
